(19) United States
(12) Patent Application Publication
(10) Pub. No.: US 2016/0358201 A1
(43) Pub. Date: Dec. 8, 2016

(54) METHOD AND SYSTEM FOR AUTOMATED SETTLEMENT OF TRANSACTION ACCOUNT REBATES

(71) Applicant: MasterCard International Incorporated, Purchase, NY (US)

(72) Inventors: George WILSON-HOWELL, Dubai (AE); Shelli Denice WERRE, St. Louis, MO (US); Kamal ATTOH, Irvine, CA (US)

(73) Assignee: MASTERCARD INTERNATIONAL INCORPORATED, Purchase, NY (US)

(21) Appl. No.: 14/732,893

(22) Filed: Jun. 8, 2015

(51) Int. Cl. G06Q 30/02

(52) U.S. Cl. CPC G06Q 30/0234

(57) ABSTRACT

A method for automated settlement of cardholder rebates includes: storing account profiles, each profile including data related to a merchant transaction account associated with a merchant registered in a rewards program including a merchant identifier and merchant funding rate; receiving a transaction message for a payment transaction, the transaction message including a plurality of data elements configured to store data associated with a transaction amount, transaction time and/or date, transaction account number, and specific merchant identifier; identifying a specific account profile including the specific merchant identifier; calculating a rebate amount based on the transaction amount; generating a data file, the data file including a transaction data entry associated with the payment transaction including the transaction time and/or date, transaction amount, specific merchant identifier, and calculated rebate amount; and automatically transmitting the data file to a financial institution associated with the merchant transaction account related to the specific account profile.

### FIELD

The present disclosure relates to the automated settlement of cardholder rebates, specifically the generation of a data file with transaction details for eligible transactions that is automatically transmitted to an acquiring financial institution for settlement of cardholder rebates.

### BACKGROUND

Financial institutions, such as banks, credit unions, and payment networks, often provide account holders with incentives in order to encourage use of various financial services and products offered by the institution. Use of the services and products may provide for increased revenue either directly or indirectly, such as by the fostering of a relationship with the account holder and corresponding additional use of institution products and services. One such incentive that is sometimes offered to a consumer is the ability to earn rebates for payment transactions conducted using a specific payment instrument, such as a payment card issued to the consumer by the financial institution.

In many systems, rebates are provided to a cardholder following use of their payment card to fund a payment transaction, after the clearing and settlement of the transaction have been completed. In many instances, once the settlement process has completed for the transaction, a payment network may transmit transaction data for the transaction to the financial institution (e.g., the bank that issued the payment card) on a per-transaction basis once the transaction has settled. The financial institution can then issue a rebate to the cardholder.

However, the configuration of existing systems can lead to a number of problems. The transmission of transaction details for each individual transaction following transaction settlement may result in a significant number of transmissions between the payment network and financial institution, which may put a strain on communication networks and may slow down processing by both entities due to the number of communications and associated tasks that must be performed. In addition, the processing of each rebate individually may result in an increased number of rebate transactions and associated fee transactions (e.g., as charged by the payment network, provided to the financial institution, etc.), which may increase expenses for the involved entities and thereby decrease revenue.

Thus, there is a need for a technical solution to enable the automatic settlement of rebates for cardholder payment transactions that can increase the efficiency of rebate processing. The aggregation of rebate transactions for automatic settlement can greatly increase processing efficiency, while also decreasing the number of communications and transactions conducted, thereby further increasing efficiency and entity revenue.

### SUMMARY

The present disclosure provides a description of systems and methods for automated settlement of cardholder rebates.

A method for automated settlement of cardholder rebates includes: storing, in a profile database, a plurality of account profiles, wherein each account profile includes data related to a merchant transaction account associated with a merchant registered in a rewards program including at least a merchant identifier and a merchant funding rate; receiving, by a receiving device, a transaction message for a payment transaction, wherein the transaction message includes a plurality of data elements configured to store data associated with at least a transaction amount, a transaction time and/or date, a transaction account number, and a specific merchant identifier; identifying, by a processing device, a specific account profile stored in the profile database where the included merchant identifier corresponds to the specific merchant identifier included in the received transaction message; calculating, by the processing device, a rebate amount based on at least the transaction amount included in the received transaction message; generating, by the processing device, a data file, wherein the data file includes at least a transaction data entry associated with the payment transaction including at least the transaction time and/or date, transaction amount, and specific merchant identifier included in the received transaction message and the calculated rebate amount; and automatically transmitting, by a transmitting device, the generated data file to a financial institution associated with the merchant transaction account related to the specific account profile.

A system for automated settlement of cardholder rebates includes a profile database, a receiving device, a processing device, and a transmitting device. The profile database is configured to store a plurality of account profiles, wherein each account profile includes data related to a merchant transaction account associated with a merchant registered in a rewards program including at least a merchant identifier and a merchant funding rate. The receiving device is configured to receive a transaction message for a payment transaction, wherein the transaction message includes a plurality of data elements configured to store data associated with at least a transaction amount, a transaction time and/or date, a transaction account number, and a specific merchant identifier. The processing device is configured to: identify a specific account profile stored in the profile database where the included merchant identifier corresponds to the specific merchant identifier included in the received transaction message; calculate a rebate amount based on at least the transaction amount included in the received transaction message; and generate a data file, wherein the data file includes at least a transaction data entry associated with the payment transaction including at least the transaction time and/or date, transaction amount, and specific merchant identifier included in the received transaction message and the calculated rebate amount. The transmitting device is configured to automatically transmit the generated data file to a financial institution associated with the merchant transaction account related to the specific account profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for automated settlement of cardholder rebates in accordance with exemplary embodiments.

FIG. 2 is a block diagram illustrating the processing server of FIG. 1 for the automated settlement of cardholder rebates in accordance with exemplary embodiments.

FIG. 3 is a flow diagram illustrating a process for the automated settlement of cardholder rebates for payment transactions using the system of FIG. 1 in accordance with exemplary embodiments.

FIG. 4 is a flow diagram illustrating a process for the automated settlement of cardholder rebates for payment transactions using the processing server of FIG. 2 in accordance with exemplary embodiments.

FIG. 5 is a flow chart illustrating an exemplary method for automated settlement of cardholder rebates in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

### System for Automated Settlement of Cardholder Rebates

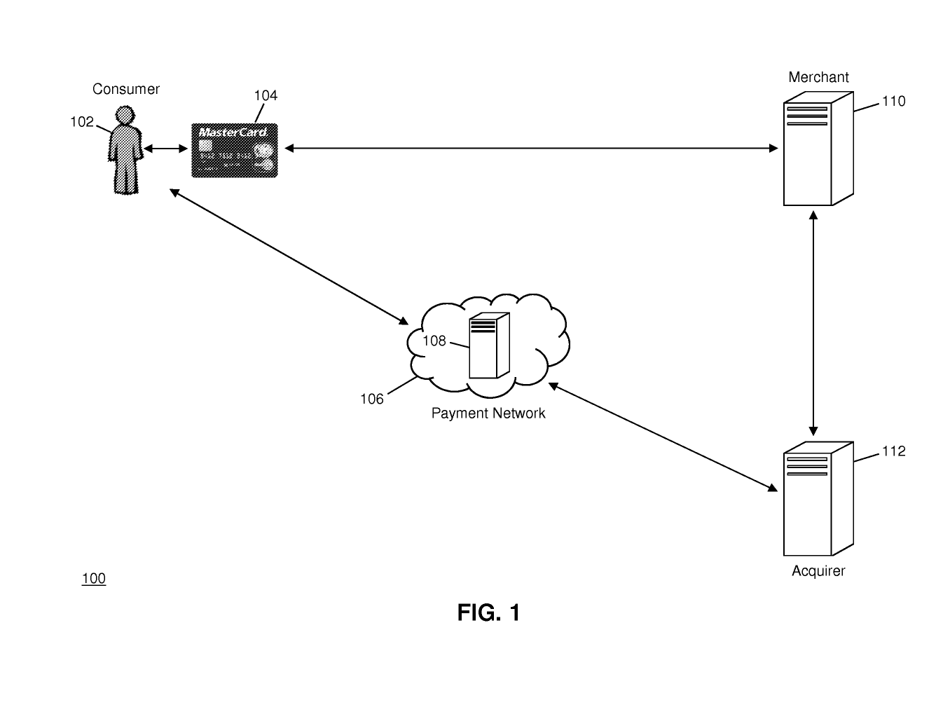

FIG. 1 illustrates a system 100 for the automated settlement of cardholder rebates via the usage of a generated data file capturing transaction data for eligible payment transactions.

In the system 100, a consumer 102 may possess a payment card 104. The payment card 104 may be issued to the consumer 102 by a financial institution, such as an issuing bank, and may be associated with a transaction account used to fund payment transactions. The payment card 104 may be registered and/or eligible (e.g., by the consumer 102 or the financial institution) for a program offered by a payment network 106 for the payment of rebates for use of the payment card 104. The program may be a rewards program or any other suitable type of reward program for which the consumer 102 may earn rebates by using the payment card 104.

The payment network 108 may include a processing server 110. The processing server 110, discussed in more detail below, may be configured to automate settlement of cardholder rebates for transactions using the methods discussed herein. The consumer 102 may use their payment card 104 to fund a payment transaction at a merchant 110. As part of the payment transaction, the merchant 110 may provide transaction details to an acquirer 112, which may be a financial institution at which the merchant 110 has a transaction account, such as an acquiring bank. The acquirer 112 may generate an authorization request for the payment transaction, and may submit the authorization request to the payment network 106 for processing. The authorization request may be a transaction message formatted based on one or more associated standards, such as the International Organization for Standardization's ISO 8583 standard. The authorization request may include a plurality of data elements, each data element being configured to store a certain type of data as set forth in the associated standards. The payment network 106 may process the payment transaction based on the data included in the received authorization request using traditional methods and systems. In some embodiments, the processing server 108 may be configured to process the transaction.

The payment network 106 may be configured to transmit a transaction message to the processing server 108, for use in automated settlement of a rebate for the transaction. In some instances, the transaction message may be the authorization request associated with the corresponding transaction. In some embodiments, the payment network 106 may be configured to determine eligibility for a transaction and may provide transaction messages to the processing server 108 only for transactions for which a rebate is eligible. In other embodiments, the processing server 108 may be configured to determine transaction eligibility. The eligibility of a transaction may be based on the involved consumer 102, the payment card 104 used in the transaction, the involved merchant 110, the associated acquirer 112, and additional data, such as transaction data included in the transaction (e.g., product data corresponding to eligible products).

The processing server 108 may receive the transaction message for an eligible payment transaction, with the transaction message including data elements configured to store at least a transaction amount, a transaction time and/or date, a transaction account number, and a merchant identifier. The transaction account number may be a primary account number associated with a transaction account used to fund the payment transaction, such as a payment card number of the payment card 104 used by the consumer 102. The merchant identifier may be a unique value associated with the merchant 110 involved in the payment transaction, such as a merchant identification number.

The processing server 108 may be configured to calculate a rebate amount for the transaction. The rebate amount may be based on at least the transaction amount and may be further based on any suitable additional data, if necessary, such as a funding rate set by the merchant 110, acquirer 112, payment network 106, issuing bank associated with the payment card 104, etc. For instance, in rebates funded by the acquirer 112, the rebate amount may be based on a rate set forth by the acquirer 112. In some instances, a rebate amount may also be based on additional transaction data, such as product data or offer data included in the transaction message (e.g., and included in the corresponding authorization request).

The processing server 108 may be configured to generate a data file. The data file may include transaction data entries for payment transactions for which a cardholder rebate is to be provided. Each transaction data entry may include transaction data associated with the transaction, such as the transaction time and/or date, transaction amount, rebate amount, and the merchant identifier associated with the involved merchant 110. In some instances, the transaction account number may also be included in the transaction data entry. The processing server 108 may provide the data file to the acquirer 112. The acquirer 112 may then pay for the consumer rebates and may, in some instances, charge the corresponding merchants 110 for reimbursement. In some embodiments, the payment network 106 and/or processing server 108 may process rebate payments to the consumers 102. In such embodiments, the acquirer 112 may reimburse or be charged by the payment network 106 and/or processing server 108 for the rebate payments.

In exemplary embodiments, the processing server 106 may append new transaction data entries for each cardholder rebate to the generated data file and then transmit the data file to the acquirer 112 automatically and at a predetermined interval of time. The predetermined interval of time may be set by the payment network 106 or the acquirer 112. For example, the acquirer 112 may set the interval to be one week. The processing server 102 may thereby send the data file to the acquirer 112 every week, and it may include transaction data entries for cardholder rebates that are paid out (e.g., by the payment network 106) or to be paid out (e.g., by the acquirer 112) for that week. The acquirer 112 may then reimburse the payment network 106 or provide a rebate to the consumers 102 accordingly, and may charge the merchants 110 for the rebate amounts or a funding amount based thereon, if applicable. By providing a data file that consists of several transaction data entries, the processing server 108 may enable the acquirer 112 to fund or provide rebates to consumers 102 more quickly and efficiently and minimize the necessary number of communications, decreasing network traffic and corresponding processing power.

In some embodiments, the processing server 106 may be configured to initiate and process payment transactions for rebate payments to consumers 102 for eligible transactions. In such embodiments, the processing server 106 may, once a rebate amount has been identified, initiate a payment transaction for payment of the rebate amount to the transaction account associated with the transaction account number included in the corresponding transaction message. By doing so, the consumer 102 may immediately receive their rebate, while the acquirer 112, an issuer, or other appropriate entity may be charged for the rebate at the predetermined interval of time. As a result, the consumer 102 and acquirer 112 may each receive the benefits provided by the processing server 108, with the consumer 102 receiving the rebate immediately and the acquirer 112 benefitting from reduced communications and faster processing time. In some instances, the processing server 108 may aggregate consumer rebate payments during a predetermined interval. For example, the processing server 108 may process rebate payments daily, and aggregate rebates for each day for a single payment to the consumer 102 if there are multiple rebates. In such instances, the consumer 102 may still receive their rebates quickly, while reducing the number of transactions processed by the payment network 106, and still providing benefits regarding communications and processing to the acquirer 112.

### Processing Server

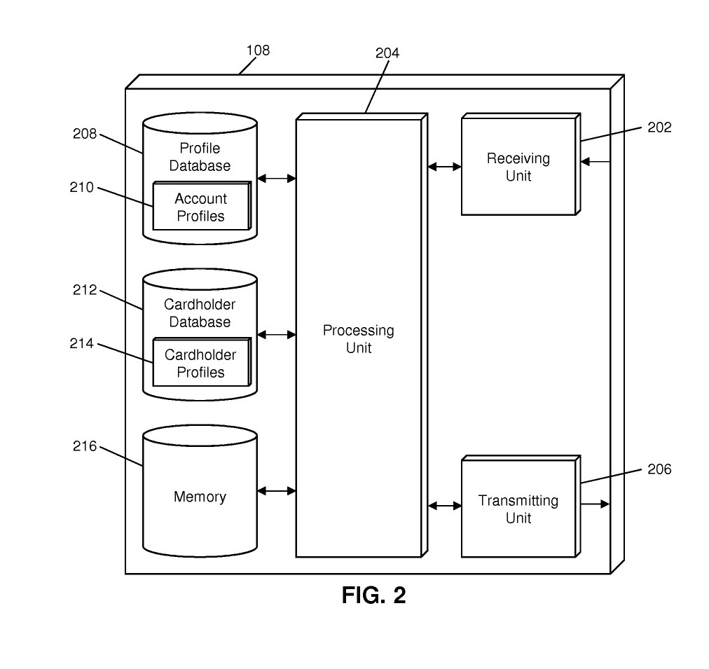

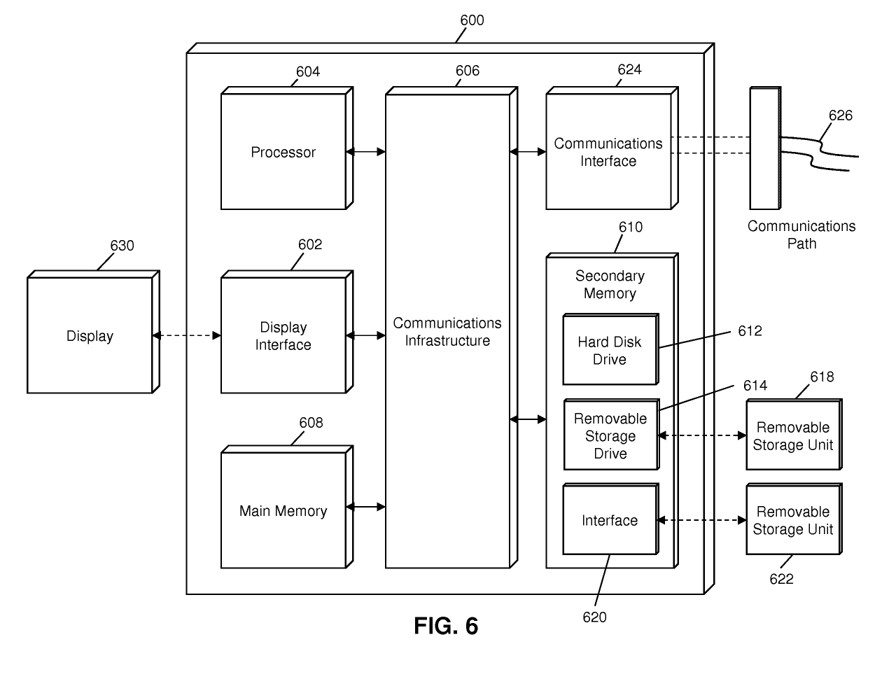

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 600 illustrated in FIG. 6 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive transaction messages, such as from merchants 110, acquirers 112, or the payment network 106. Transaction messages may be formatted pursuant to one or more standards, for which the receiving unit 202 may be configured to receive data using associated protocols. The receiving unit 202 may also be configured to receive account information associated with transaction accounts, such as for consumer accounts, merchant accounts, and/or acquirer accounts.

The processing server 108 may include a profile database 208. The profile database 208 may be configured to store a plurality of account profiles 210. Each account profile 210 may be configured to store data related to a transaction account associated with a merchant 110. In some instances, each merchant 110 associated with a transaction account related to an account profile 210 in the profile database 208 may be registered with the payment network and/or processing server 108 in a rewards program used to reward consumers 102 with cardholder rebates. Account profiles 210 may include at least a merchant identifier and a merchant funding rate. The merchant identifier may be a unique value suitable for use in identification of the account profile 210 or associated merchant 110, such as a merchant identification number, point of sale identifier, transaction account number, etc. The merchant funding rate may be a rate for use in determining the merchant's reimbursement to an acquirer 112 for payment of a rebate, the merchant's payment of a rebate based on a transaction amount, etc.

In some embodiments, the processing server 108 may also include a cardholder database 212. The cardholder database 212 may include a plurality of cardholder profiles 214. Each cardholder profile 214 may be associated with a consumer transaction account, such as a transaction account for which a payment card 104 has been issued. In some instances, each cardholder profile 214 may be associated with a transaction account for which the corresponding consumer 102 has registered or is eligible with the payment network 106 and/or processing server 108 for rebates. The cardholder profile 214 may include at least an account identifier, such as a transaction account number. In some instances, a cardholder profile 214 may include additional data, such as related to terms for cardholder rebates, such as rebate amounts, terms and conditions, aggregated transaction amounts, time and/or date information, etc.

The processing server 108 may also include a processing unit 204. The processing unit 204 may be configured to perform the functions of the processing server 108 discussed herein as will be apparent to persons having skill in the relevant art. The processing unit 204 may be configured to identify account profiles 210 in the account database 208 upon receipt of a transaction message by the receiving unit 202, using the merchant identifier included therein. In embodiments where the processing server 108 includes a cardholder database 212, the processing unit 204 may identify a cardholder profile 214 associated with the received transaction message, such as based on an account identifier included in a data element included in the transaction message, such as a data element configured to store a primary account number. The processing unit 204 may also be configured to determine eligibility for a transaction for a rebate. Eligibility may be based on data included in the identified account profile 210, identified cardholder profile 214, if applicable, transaction data stored in the data elements in the received transaction message, and other suitable data.

For eligible transactions, the processing unit 204 may be further configured to calculate rebate amounts and append a corresponding transaction data entry in the rebate data file. The rebate data file may include a plurality of transaction data entries, each including data corresponding to a consumer rebate including at least a merchant identifier, rebate amount, and transaction time and/or date. In some embodiments, the processing unit 204 may be configured to process, or to initiate processing of, payment transactions for payments of rebates, and/or for reimbursement payments by merchants 110 to acquirers 112.

The processing server 108 may also include a transmitting unit 206. The transmitting unit 206 may be configured to transmit data over one or more networks via one or more network protocols. The transmitting unit 206 may be configured to transmit generated data files to acquirers 112, such as for use in initiating cardholder rebate payments and merchant reimbursement payments. In some instances, rebate data files may be transmitted at a predetermined interval, such as one week. The transmitting unit 206 may also be configured to transmit transaction requests, which may be formatted as transaction messages, to the payment network 106, such as for rebate payments to consumers 102, reimbursement payments to acquirers 112, or reimbursement payments from acquirers 112.

The processing server 108 may also include a memory 216. The memory 216 may be configured to store data suitable for use in performing the functions discussed herein. For example, the memory 216 may be configured to store rules and/or algorithms for calculating rebate amounts or merchant reimbursement amounts, for formatting transaction messages, for generating data files, for sending and receiving transaction messages, for initiating payment transactions, for processing payment transactions, etc. Additional data that may be stored in the memory 216 will be apparent to persons having skill in the relevant art.

It will also be apparent to persons having skill in the relevant art that the processing server 108 may include additional components, and/or that the components of the processing server 108 as illustrated in FIG. 2 and discussed herein may be further configured to perform additional functions. For example, in embodiments where the processing server 108 may be configured to process payment transactions as part of the payment network 106, the processing server 108 may include additional components configured to perform, and/or the components of the processing server 108 discussed herein may be configured to perform traditional functions of the payment network 106 for processing payment transactions.

### Process for Automated Settlement of Cardholder Rebates

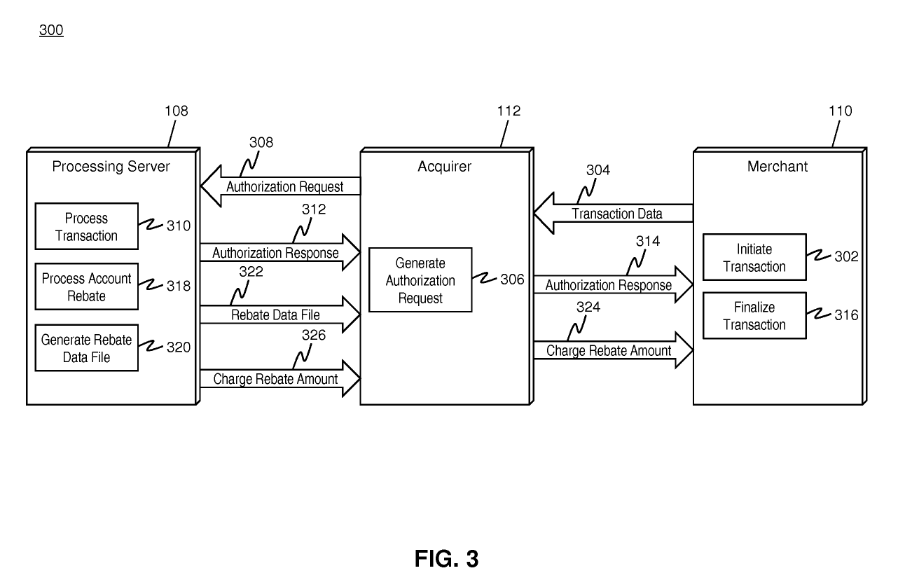

FIG. 3 illustrates a process 300 for the automated settlement of cardholder rebates using the system 100.

In step 302, the merchant 110 may initiate a payment transaction with a consumer 102 for the purchase of goods and/or services. Initiation of the payment transaction may include, for instance, the entry of transaction data into a point of sale by an employee (e.g., in an in-person transaction) or by the consumer 102 (e.g., in a remote transaction, such as using the Internet). In step 304, the merchant 110 may transmit transaction data for the payment transaction to their acquirer 112 using known methods and systems.

In step 306, the acquirer 112 may generate an authorization request for the payment transaction using the received transaction data. The authorization request may be formatted based on one or more standards and be configured to store a plurality of data elements, including at least data elements configured to store a transaction amount, a transaction time and/or date, a primary account number, and a merchant identifier. In step 308, the acquirer 112 may transmit the authorization request to the processing server 108 via the payment network 106, using associated communication protocols, such as the payment rails.

The receiving unit 202 of the processing server 108 may receive the authorization request and, in step 310, the processing unit 204 of the processing server 108 may process the payment transaction using traditional methods and systems. The processing of the payment transaction may result in the generation and/or receipt (e.g., from an issuer associated with the transaction account used to fund the payment transaction) of an authorization response indicating approval or denial of the transaction. In step 312, the transmitting unit 206 of the processing server 108 may transmit the authorization response to the acquirer 112. In step 314, the acquirer 112 may forward the authorization response to the merchant 110, and, in step 316, the merchant 110 may finalize the transaction accordingly, such as by furnishing the consumer 102 with the transacted—for products and a receipt for the transaction.

In step 318, the processing unit 204 may process a rebate for the transaction account used to fund the payment transaction, such as associated with the consumer 102 and/or payment card 104. The processing of a rebate may include calculating a rebate amount, such as based on the transaction amount included in the corresponding data element in the received authorization request, and initiating and/or processing a payment transaction for payment of the rebate amount to the transaction account used to fund the payment transaction. In some embodiments, step 318 may include only calculation of the rebate amount and any other functions associated thereto (e.g., determination of eligibility of the transaction for a rebate), and may not include initiation of the rebate transaction.

In step 320, the processing unit 204 of the processing server 108 may generate a rebate data file. The rebate data file may include a transaction data entry associated with the processed payment transaction including at least the transaction time and/or date and merchant identifier included in the corresponding data elements in the received authorization request and the calculated rebate amount. In instances where the processing server 108 has not processed a rebate payment to the consumer 102, the transaction data entry may also include the primary account number included in the corresponding data element in the received authorization request. In cases where a data file may have been previously generated, step 320 may include adding an additional transaction data entry to the existing rebate data file for the payment transaction. In step 322, the transmitting unit 206 of the processing server 108 may transmit the rebate data file to the acquirer 112. In some embodiments, step 322 may be performed at a predetermined interval. In some instances, the rebate data file may be transmitted automatically (e.g., without specific instruction) to the acquirer 112, such as at the predetermined interval, automatically upon generation of the data file, automatically upon the addition of a predetermined number of transaction data entries to the generated data file, etc.

In step 324, the acquirer 112 may charge the merchant 110 for the rebate amount for any transactions for which a rebate has been or is to be issued that involved the merchant 110, which may be identifiable based on the merchant identifier included in transaction data entries in the rebate data file. In step 326, the processing server 108 may charge the acquirer 112 for the rebate amount. It will be apparent to persons having skill in the relevant art that step 326 may be an optional step, and may not be performed if the processing server 108 did not previously initiate payment of the rebate to the consumer 102. In such instances, step 326 may be replaced by the initiation of the transaction for payment of the rebate amount by the acquirer 112.

### Automated Settlement of Cardholder Rebates

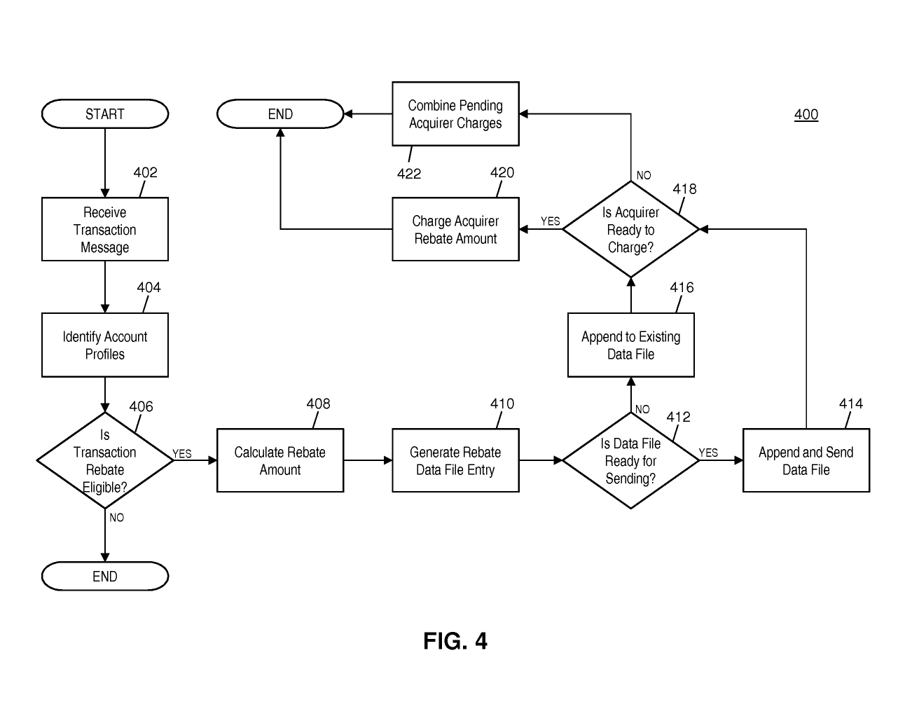

FIG. 4 illustrates a process 400 for the automated settlement of cardholder rebates using the processing server 108 as illustrated in FIG. 2.

In step 402, the receiving unit 202 of the processing server 108 may receive a transaction message associated with a payment transaction, such as from the acquirer 112 or payment network 106. The transaction message may be formatted based on one or more standards and include a plurality of data elements, each configured to store data, including data elements configured to store a transaction amount, transaction time and/or date, primary account number, and merchant identifier. In step 404, the processing unit 204 of the processing server 108 may identify an account profile 210 associated with a merchant 110 involved in the transaction based on the merchant identifier included in the received authorization request. In instances where the processing server 108 includes the cardholder database 112, the processing unit 204 may also identify a cardholder profile 214 associated with a cardholder involved in the transaction based on the primary account number.

In step 406, the processing unit 204 may determine if the transaction is eligible for a rebate. Eligibility may be based on transaction data as included in one or more data elements in the received authorization request and any additional criteria that may be suitable, such as data stored in the identified account profile 210 and cardholder profile 214, if applicable. In some instances, eligibility may be determined (e.g., by the payment network 106) prior to receipt of the transaction message. If the transaction is not eligible for a rebate, then the process 400 may be completed.

If the transaction is eligible for a rebate, then, in step 408, the processing unit 204 may calculate a rebate amount. The rebate amount may be based on at least the transaction amount included in the corresponding data element in the received transaction message, and may also be based on a merchant funding rate stored in the identified account profile 210, a rate established by the acquirer 112, rebate data stored in the identified cardholder profile 214, rules set forth in the memory 216, etc. In step 410, the processing unit 204 may generate a transaction data entry for the rebate data file corresponding to the payment transaction. The transaction data entry may include at least the calculated rebate amount and the transaction amount, transaction time and/or date, and merchant identifier included in the corresponding data elements in the received transaction message.

In step 412, the processing unit 204 may determine if the data file is ready for transmission to the acquirer 112. The determination may be made, for example, based on time, such as if the data file is to be transmitted at a predetermined interval, based on the amount of transaction data entries included in the data file, or may be ready for transmission on a per-transaction basis. If the data file is ready for sending, then, in step 414, the processing unit 204 may append the new transaction data entry to the data file and the transmitting unit 206 of the processing server 108 may transmit the data file to the acquirer 112, which an issuer may then use to provide rebates to consumers 102 and for the acquirer 112 to collect reimbursements from merchants 110.

If, in step 412, the processing unit 204 determines that the data file is not ready to send, then, in step 416, the processing unit 204 may append the new transaction data entry to the rebate data file and wait for transmission. Once the data file has been appended and, if applicable, transmitted, then, in step 418, the processing unit 204 may determine if the acquirer 112 is to be charged. The determination may be based on a predetermined interval, payment of the corresponding rebate, an aggregate payment amount, an acquirer revenue amount, and/or other suitable criteria. For example, the acquirer 112 may only be charged after a specific aggregate amount of rebates have been paid out. If the acquirer 112 is ready to be charged, then, in step 420, the acquirer 112 may be charged for an outstanding rebate amount by the processing unit 204 of the processing server 108 (e.g., and via the payment network 106). If the acquirer 112 is not ready to be charged, any amount associated with the payment transaction may be combined to other charges that are pending for the acquirer 112 for aggregation of all pending charges. In such an instance, the pending charges may be charged later, such as at a predetermined interval.

### Exemplary Method for Automated Settlement of Cardholder Rebates

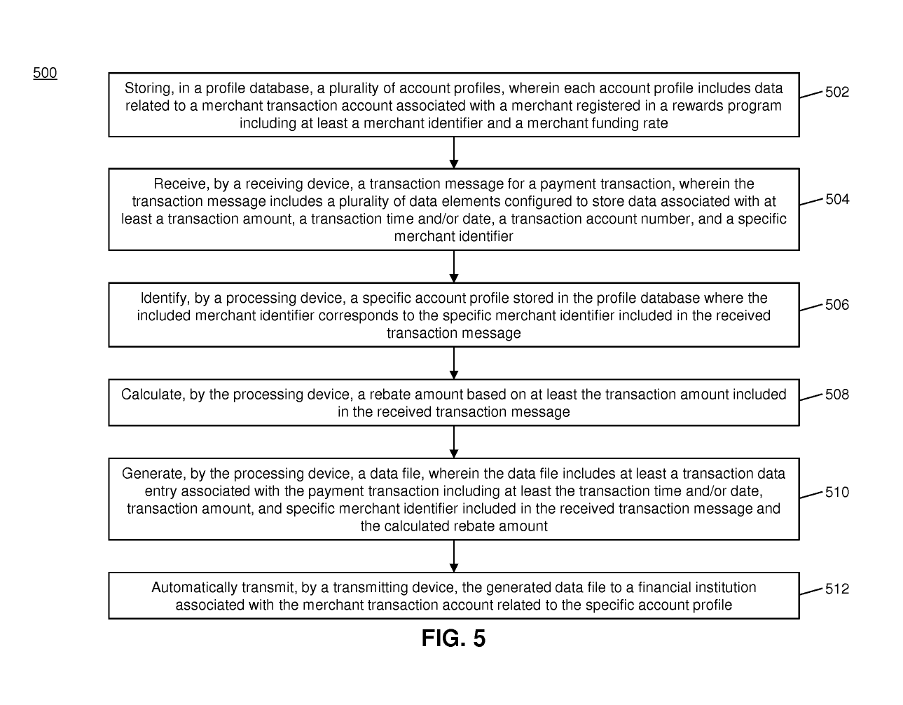

FIG. 5 illustrates a method 500 for automated settlement of cardholder rebates via use of a data file generated for rebate-eligible transactions.

In step 502, a plurality of account profiles (e.g., account profiles 210) may be stored in a profile database (e.g., the profile database 208), wherein each account profile 210 includes data related to a merchant transaction account associated with a merchant (e.g., merchant 110) registered with or eligible for a rewards program including at least a merchant identifier and a merchant funding rate. In step 504, a transaction message for a payment transaction may be received by a receiving device (e.g., the receiving unit 202), wherein the transaction message includes a plurality of data elements configured to store data associated with at least a transaction amount, a transaction time and/or date, a transaction account number, and a specific merchant identifier.

In step 506, a specific account profile 210 stored in the profile database 208 may be identified by a processing device (e.g., the processing unit 204) where the included merchant identifier corresponds to the specific merchant identifier included in the received transaction message. In step 508, a rebate amount may be calculated by the processing device 204 based on at least the transaction amount included in the received transaction message. In one embodiment, the rebate amount may be further based on the merchant funding rate included in the identified specific account profile 210.

In step 510, a data file may be generated by the processing device 204, wherein the data file includes at least a transaction data entry associated with the payment transaction including at least the transaction time and/or date, transaction amount, and specific merchant identifier included in the received transaction and the calculated rebate amount. In step 512, the generated data file may be automatically transmitted by a transmitting device (e.g., the transmitting unit 206) to a financial institution (e.g., the acquirer 112) associated with the merchant transaction account related to the specific account profile 210.

In one embodiment, the method 500 may further include initiating, by the processing device 204, payment of the calculated rebate amount to a transaction account associated with the transaction account number included in the received transaction message. In some embodiments, the method 500 may also include initiating, by the processing device 204, a charge for the calculated rebate amount to a transaction account associated with the financial institution 112. In a further embodiment, the charge may be initiated automatically by the processing device 204.

In one embodiment, the method 500 may further include: repeating the receiving, identifying, and calculating steps for an additional payment transaction; and appending, to the generated data file, an additional transaction data entry associated with the additional payment transaction. In a further embodiment, the generated data file may be automatically transmitted by the transmitting device 206 at a predetermined interval. In another further embodiment, the method 500 may even further include initiating, by the processing device 204, a charge for the calculated rebate amount to a transaction account associated with the financial institution 112. In an even further embodiment, the initiating step may be repeated for the additional payment transaction, the generated data file may be automatically transmitted by the transmitting device 206 at a first interval of time, and the charge may be automatically initiated by the processing device 204 at a second interval of time. In another even further embodiment, the first interval of time may be shorter than the second interval of time.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for automated settlement of cardholder rebates. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automated settlement of cardholder rebates, comprising:
storing, in a profile database, a plurality of account profiles, wherein each account profile includes data related to a merchant transaction account associated with a merchant registered in a rewards program including at least a merchant identifier and a merchant funding rate;
receiving, by a receiving device, a transaction message for a payment transaction, wherein the transaction message includes a plurality of data elements configured to store data associated with at least a transaction amount, a transaction time and/or date, a transaction account number, and a specific merchant identifier;
identifying, by a processing device, a specific account profile stored in the profile database where the included merchant identifier corresponds to the specific merchant identifier included in the received transaction message;
calculating, by the processing device, a rebate amount based on at least the transaction amount included in the received transaction message;
generating, by the processing device, a data file, wherein the data file includes at least a transaction data entry associated with the payment transaction including at least the transaction time and/or date, transaction amount, and specific merchant identifier included in the received transaction message and the calculated rebate amount; and
automatically transmitting, by a transmitting device, the generated data file to a financial institution associated with the merchant transaction account related to the specific account profile.

2. The method of claim 1, further comprising:
initiating, by the processing device, payment of the calculated rebate amount to a transaction account associated with the transaction account number included in the received transaction message.

3. The method of claim 1, wherein the rebate amount is further based on the merchant funding rate included in the identified specific account profile.

4. The method of claim 1, further comprising:
initiating, by the processing device, a charge for the calculated rebate amount to a transaction account associated with the financial institution.

5. The method of claim 4, wherein the charge is initiated automatically by the processing device.

6. The method of claim 1, further comprising:
repeating the receiving, identifying, and calculating steps for an additional payment transaction; and
appending, to the generated data file, an additional transaction data entry associated with the additional payment transaction.

7. The method of claim 6, wherein the generated data file is automatically transmitted by the transmitting device at a predetermined interval.

8. The method of claim 6, further comprising:
initiating, by the processing device, a charge for the calculated rebate amount to a transaction account associated with the financial institution.

9. The method of claim 8, wherein
the initiating step is repeated for the additional payment transaction,
the generated data file is automatically transmitted by the transmitted device at a first interval of time, and
the charge is automatically initiated by the processing device at a second interval of time.

10. The method of claim 9, wherein the first interval of time is shorter than the second interval of time.

11. A system for automated settlement of cardholder rebates, comprising:
a profile database configured to store a plurality of account profiles, wherein each account profile includes data related to a merchant transaction account associated with a merchant registered in a rewards program including at least a merchant identifier and a merchant funding rate;
a receiving device configured to receive a transaction message for a payment transaction, wherein the transaction message includes a plurality of data elements configured to store data associated with at least a transaction amount, a transaction time and/or date, a transaction account number, and a specific merchant identifier;
a processing device configured to
identify a specific account profile stored in the profile database where the included merchant identifier corresponds to the specific merchant identifier included in the received transaction message,
calculate a rebate amount based on at least the transaction amount included in the received transaction message, and
generate a data file, wherein the data file includes at least a transaction data entry associated with the payment transaction including at least the transaction time and/or date, transaction amount, and specific merchant identifier included in the received transaction message and the calculated rebate amount; and
a transmitting device configured to automatically transmit the generated data file to a financial institution associated with the merchant transaction account related to the specific account profile.

12. The system of claim 11, wherein the processing device is further configured to initiate payment of the calculated rebate amount to a transaction account associated with the transaction account number included in the received transaction message.

13. The system of claim 11, wherein the rebate amount is further based on the merchant funding rate included in the identified specific account profile.

14. The system of claim 11, wherein the processing device is further configured to initiate a charge for the calculated rebate amount to a transaction account associated with the financial institution.

15. The system of claim 14, wherein the charge is initiated automatically by the processing device.

16. The system of claim 11, wherein the processing device is further configured to
repeat the receiving, identifying, and calculating steps for an additional payment transaction, and
append, to the generated data file, an additional transaction data entry associated with the additional payment transaction.

17. The system of claim 16, wherein the generated data file is automatically transmitted by the transmitting device at a predetermined interval.

18. The system of claim 16, wherein the processing device is further configured to initiate a charge for the calculated rebate amount to a transaction account associated with the financial institution.

19. The system of claim 18, wherein
the initiating step is repeated for the additional payment transaction, the generated data file is automatically transmitted by the transmitted device at a first interval of time, and
the charge is automatically initiated by the processing device at a second interval of time.

20. The system of claim 19, wherein the first interval of time is shorter than the second interval of time.
